(19) United States
(12) Patent Application Publication
(10) Pub. No.: US 2007/0289849 A1
(43) Pub. Date: Dec. 20, 2007

(54) Electro-Mechanical Programmer and Programmable Electrical Connector Comprising One Such Programmer

(76) Inventor: Romain Guillot, Mionnay (FR)

Correspondence Address: Ralph A. Dowell of DOWELL & DOWELL P.C., 2111 Eisenhower Ave, Suite 406, Alexandria, VA, 22314, US

(21) Appl. No.: 11/663,952

(22) PCT Filed: Sep. 28, 2005
(86) PCT No.: PCT/FR05/02398

§ 371 Date: May 17, 2007

(30) Foreign Application Priority Data
Sep. 29, 2004 (FR) 0410306

(51) Int. Cl. H01H 43/06

(52) U.S. Cl. 200/36

(57) ABSTRACT

The invention relates to an electromechanical programmer which contains a rotary display dial and segments for determining at least one programming range which is supported by the dial such that it can move between two different control positions, and where each of the segments passing from one control position to the other by tilting around an axis is orthoradial in relation to the axis of rotation of the dial. Moreover, each segment consists of a body with an essentially-C-shaped cross-section, including an inner face which is directed towards the dial and which extends around the tilting axis of the segment and another surface which, in the control position, covers an associated zone of the dial and which, in the other control position, uncovers and exposes at least part of the zone to the exterior. The displaying of one or more uncovered portions of the zone provides the user with immediately-comprehensible information relating to the programming ranges.

The present invention relates to an electromechanical programmer as well as a programmable electrical connector comprising such a programmer.

The invention is applicable in particular to the field of home automation and, more generally, to the automated control of an electrical appliance for the purpose of supplying power to this appliance according to an adjustable timing cycle.

The present-day programmable connectors intended to be electrically interposed between a current source and an appliance are adapted to enable power to be supplied to this appliance by the source only during one or several time intervals in a cyclical manner, generally with a period of one day. For this purpose such a connector is traditionally equipped with an electromechanical programmer, which is more economical than an electronic programming device. This programmer has a programming dial, generally in the form of a wheel, provided with graduations corresponding to temporal sub-divisions of the period of the programming cycle. In the region of each of these sub-divisions the dial is equipped with a segment which can be actuated by the user in such a way as to determine the time range or ranges during which the supply of electrical power is desired. The programmer further comprises means for driving the programming dial in rotation in such a way that the dial carries out a complete revolution in one period of the cycle, for example in twenty-four hours.

Different types of segments are used nowadays. Some of them are in the form of eyelash-like flexible strips capable of deforming radially towards the exterior with respect to the axis of rotation of the dial. These segments have the advantage of small dimensions but they do not indicate very clearly to the user whether or not they are in a deformed position unless they are studied carefully one by one. Thus the programming range or ranges is/are difficult to adjust and tiresome to check.

Other segments are formed by rigid bars which can be displaced in translation either in a radial direction or in an axial direction with respect to the dial. These segments are even more lacking in visibility than the preceding ones and are more resistant to displacement.

DE-U-88 03 546 proposes another form of segments, borne by the dial in such a way that they tilt between their two control positions about an axis which is orthoradial with respect to the axis of rotation of the dial. In order to pass from one position to the other, each segment slides against a complementary convex surface of the dial. However, regardless of whether the segment is in one control position or in the other, this convex surface is permanently covered by the segment and is never visible from the exterior. In practice, when the user seeks to determine whether one of the segments is in one or the other of the positions he looks at the position of a pin projecting from the external face of the segment, wherein moreover this pin serves to drive the segment so as to tilt during the programming. In use, the observation of these pins proves particularly tiresome for the user, particularly because of their small dimensions and their lack of contrast in relation to the rest of the segment. Moreover, during the manipulation of these segments the user does not really have the sensation of tilting kinematics but rather the sensation of kinematics of translation because of the small tilting angle and the small curvature of the convex surface of the dial along which the segment slides.

Furthermore, in all cases the present-day segments run the risk of not being completely displaced into one of the two end positions and thereby occupying an intermediate position which may make the user think that an active or inactive range is programmed when in fact the badly positioned segment will cause the control to be the opposite of that expected. Such an intermediate position can even lead to total jamming of the programmer.

The object of the present invention is to propose an electromechanical programmer in which the programming segments offer better visibility whilst being robust, easy to use and reliable.

To this end the invention relates to an electromechanical programmer comprising a rotary display dial and rigid or semi-rigid segments for determining at least one programming range which are supported by the dial in such a way that they can move between two different control positions, each segment passing from one control position to the other by tilting about an axis which is orthoradial with respect to the axis of rotation of the dial, characterised in that each segment comprises a body with a substantially C-shaped cross-section of which the inner face directed towards the dial extends about the axis of tilting of the segment and includes a surface which in one control position covers an associated zone of the dial and in the other control position uncovers at least part of the said zone of the dial and renders it visible from the exterior.

By virtue of the tilting kinematics associated with the C shape defined above, the zone of the dial which is selectively covered or uncovered, that is to say selectively masked or rendered visible from the exterior, by the internal face of the segments is wide and therefore easy for the user to see. Therefore the programmer according to the invention offers high visibility of the programmed range or ranges and thus greater satisfaction for the user.

The programmer according to the invention advantageously also comprises coloured and/or luminous means for marking the zone of the dial which is selectively covered or uncovered by the segments, which guarantees excellent visibility of the programmed range or ranges even when the display dial is observed from a distance.

According to other characteristics of this programmer, considered in isolation or in any technically possible combination:
the marking means comprise at least one light guiding element, adapted to guide a light to the zone of the dial which is selectively covered or uncovered by the segments;
the tilting angle of each segment between the two control positions has a value higher than 28°, preferably approximately 30°;
the zone of the dial forms a truncated cone converging towards the axis of rotation of the dial in the direction of a display face of the dial;
the apex angle of the said truncated cone is approximately 90°;
the face of each segment directed towards the dial also includes a surface provided with a means for mounting so as to tilt on the dial;
the means for mounting so as to tilt comprise a catch engaged on a ring of the dial, this ring being centred on the axis of rotation of the dial and having a circular cross-section centred on the axis of tilting of the segment;
it further comprises means for locking of each segment in each of its control positions, adapted in order to co-operate with the segment by means of complementary shapes;
each segment has two adjacent recesses to receive a complementary part of the locking means, and the recesses have respective cam surfaces for the said complementary part which open onto one another and are adapted to push this part during the tilting of the segment, the locking means comprising an element for resiliently returning the complementary part to the base of the recesses;
the cam surfaces are joined directly to one another by a convex angular zone.

The invention also relates to a programmable electrical connector comprising an electrical input plug, at least one electrical output socket and a programmer as defined above, adapted to control the flow and the interruption of the current between the input plug and the or at least one of the output sockets.

The invention will be better understood by reading the following description which is given solely by way of example and with reference to the drawings, in which:

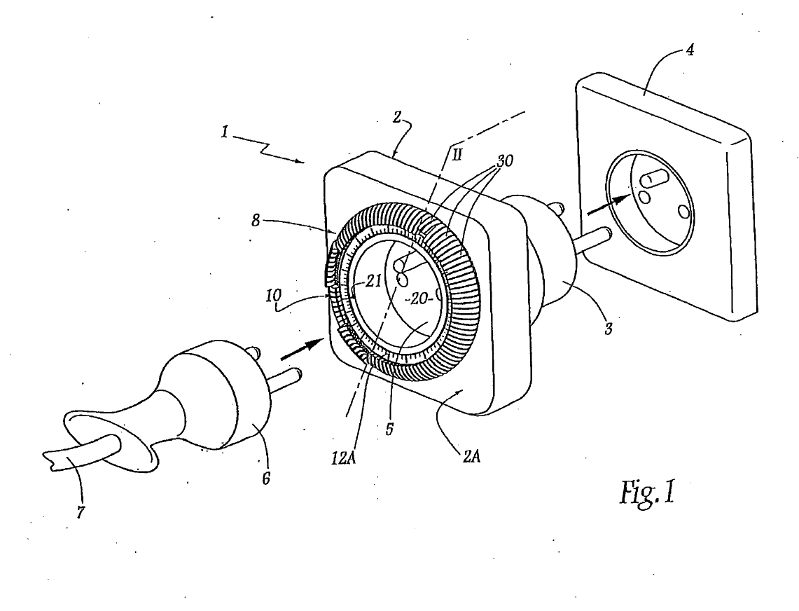

FIG. 1 shows a perspective view of an electrical connector according to the invention;

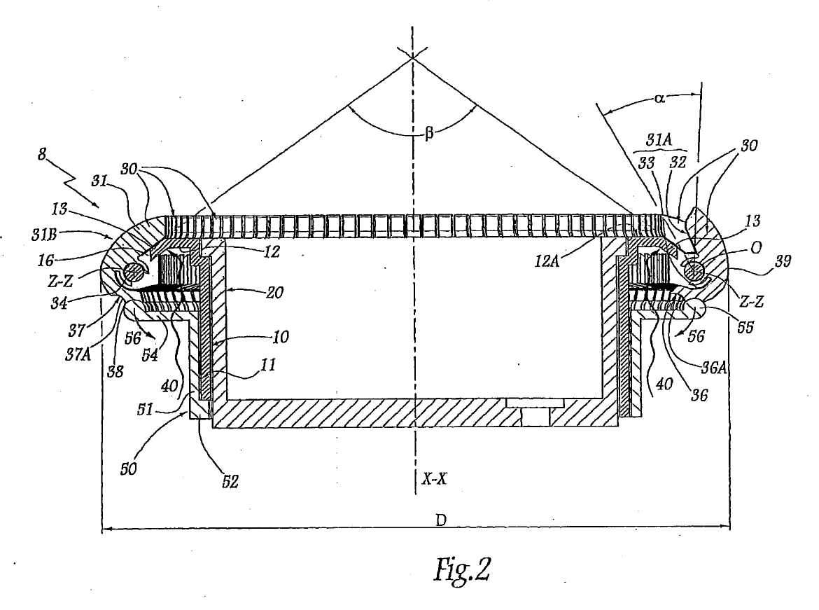

FIG. 2 shows a sectional view along the plane II indicated in FIG. 1 of a part of a programmer with which the connector of FIG. 1 is equipped;

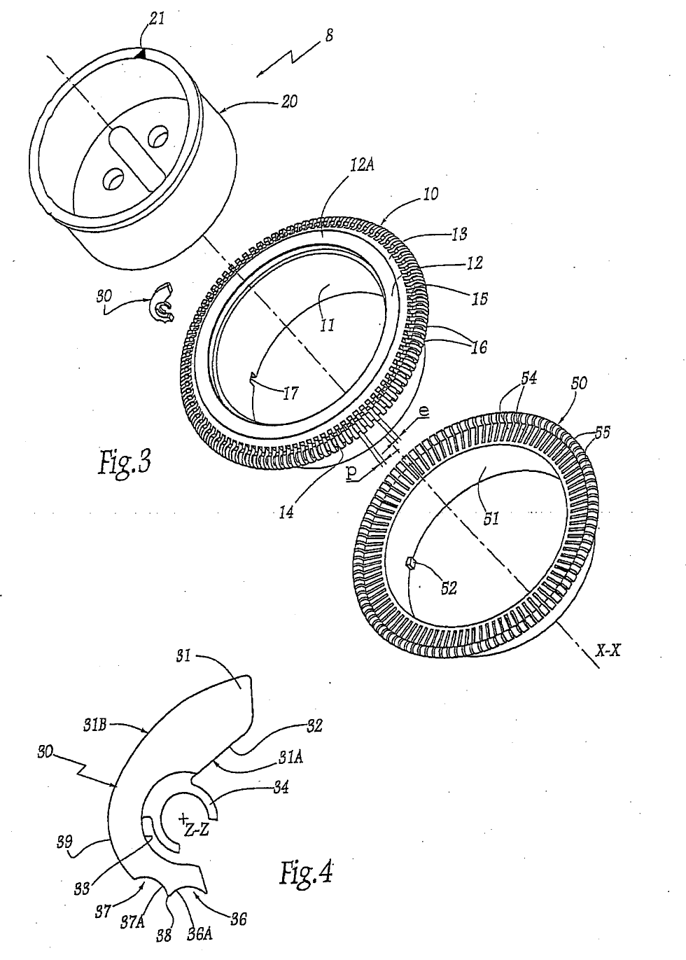

FIG. 3 shows an exploded perspective view of some of the components of the programmer shown in FIG. 2; and

FIG. 4 shows a side view on an enlarged scale of a segment of the connector of FIGS. 1 to 3.

In FIG. 1 a programmable electrical connector 1 is shown which comprises an electromechanical programmer 8 which is partially visible in FIG. 1, the rest of the programmer being accommodated in an external housing 2 of the connector. The connector 1 further comprises on the one hand an input plug 3 adapted to be introduced into a socket 4, such as a wall socket, and on the other hand an output socket 5 adapted to receive a plug 6 forming the end of an electrical power supply cord 7 of an appliance. The programmer 8 is intended to control the passage of the current between the wall socket 4 and the cord 7 as a function of programming parameters chosen by the user.

As shown in greater detail in FIGS. 2 to 4, the programmer 8 comprises a programming dial 10 comprising a tubular wheel mounted so as to rotate about its longitudinal axis X-X about a coaxial insert 20 adapted to be joined to the housing 2. This insert constitutes the part of the socket 5 of the connector 1 which is visible from the exterior of the housing and internally delimits the zone for receiving the plug 6 at the end of the cord 7.

At its end which faces towards the exterior of the housing 2, the wheel 11 is provided with an annular flange 12 which is substantially flat and is extended radially towards the exterior by an edge in the shape of a truncated cone with an axis X-X and converging at a point opposite the plug 3, the apex angle β of this truncated cone being approximately 90°. In other words, the edge 13 forms a truncated cone extending continuously over the entire external periphery of the flange 12. On its face 12A directed towards the exterior of the housing the flange 12 has a series of graduations distributed uniformly around the periphery of the dial and shown only in FIG. 1. These graduations comprise twenty-four principal graduations as well as three secondary graduations between two successive principal graduations. In operation the dial 10 is intended to carry out one complete revolution on itself about the insert 20 in twenty-fours and at a constant speed, such that each principal graduation corresponds to one hour of the day whilst the three secondary graduations between two successive principal graduations correspond to the quarters of an hour between two successive hours. For this purpose the programmer 8 is provided with means (not shown) for driving the dial in rotation and at a constant speed, these means being accommodated in the housing 2.

In order to indicate in time the angular position of the rotary dial, the programmer 8 is provided with a time marker 21, for example in the form of an arrow in relief on the insert 20.

The dial 10 also comprises a ring 14 with a circular cross-section having a centre O, coaxial with the wheel 11 and situated outside this wheel. The ring 14 is rigidly connected to the wheel 11 by radial tabs 15 of which the external end part 16 forms an annular rib centred on O and surrounding the ring 14. The dial 10 has ninety-six ribbed tabs 15 uniformly distributed about the wheel 11. Each tab 15 has a thickness e, that is to say a substantially constant dimension, around the periphery of the dial. Two successive tabs are spaced from one another by a peripheral distance p (FIG. 3).

The programmer 8 comprises segments 30 attached to the dial 10 along the external periphery thereof. Each segment 30 is composed of a rigid or semi-rigid body approximately in the shape of a crescent, that is to say it has a substantially C-shaped section in the plane of FIG. 2. On its internal face 31A the body 31 forms a surface 32 which is substantially complementary to the edge 13, this surface being flat in the example under consideration, and a substantially semi-cylindrical surface 33. This surface 33 is complementary to the annular ribs 16 of the dial 10 and has projecting from its central part a catch 34 which is adapted to engage on the ring 14 of the dial 10. Each segment 30 mounted rotatably on the ring 14 by means of its catch 34 can tilt with respect to the dial 10 about an axis Z-Z which is orthoradial with respect to the axis X-X and passes through the point O, between a closed position shown in the left-hand part of FIG. 2 and an open position shown in the right-hand part of this figure. During tilting, the segment 30 is guided by its surface 33 sliding on the peripheral edge of the two ribs 16 situated on either side of the portion of the ring 14 engaged by the catch 34.

The external face 31B of each segment 30 is substantially curved about the axis Z-Z. the part 39 of this face 31B which is furthest from the axis X-X forms a substantially spherical surface centred on the axis Z-Z in such a way that when the segment passes from one open or closed position to the other the maximum diametral dimension D of the programmer 8, that is to say the dimension of the programmer in the plane both perpendicular to the axis X-X and passing through the axes of tilting Z-Z, is unchanged.

The programmer 8 has ninety-six segments 30, each segment being associated with an angular sector which separates from one another either two successive secondary graduations on the face 12A of the wheel 11 or a principal graduation and a secondary graduation in succession. Depending upon whether a segment 30 is in the closed or open position, the flow of electrical current between the plug 3 and the socket 5 of the connector 1 is respectively interrupted or ensured by means of a mechanical system for detection of the position of the segment which is known to the specialist in the field under consideration and will not be described in greater detail below. In this way the user can program, by means of at least one open segment 30, one or several time ranges with a minimum duration of a quarter of an hour during which the electric cord 7 is supplied by the wall socket 4. The ranges defined by the segments 30 control the interruption of the current through the connector 1. Thus in the example illustrated in FIG. 1, the cord 7 is supplied with current during three ranges of durations equal respectively to thirty minutes, two hours and again two hours.

The catch 34 has a width substantially equal to the peripheral spacing p separating two successive tabs 15 so that when the catch 34 is clipped on the ring 14 the segment 30 is fixed angularly around the dial 10 by retention of its catch 34 between two successive ribs 16. Furthermore, the total width of the surface 33 is substantially equal to the sum of the spacing p and the thickness e of the ribs 16. In this way when the ninety-six segments 30 are clipped, these segments are juxtaposed in such a manner that they are substantially contiguous over the entire periphery of the dial.

In order to offer the user high visibility of the programming ranges, the flat surface of each segment is dimensioned so as to recover virtually all of the corresponding portion of the edge 13 of the wheel 11 when the segment is in the closed position, whilst when this segment is in the open position this portion is totally uncovered and therefore visible to the user looking at the front face 2A of the housing 2. The angle a of tilting of the segment between its closed and open positions advantageously has a value higher than 28°. This value is preferably substantially equal to 30° which, when the segment is open, guarantees good visibility of the edge 13 inclined at 45° with respect to a plane perpendicular to the axis X-X. Thus this inclination enables a good display of the programmed ranges about the graduated face 12A of the dial, both when the user looks at the programmer from the front, that is to say in a direction substantially normal to the graduated face 12A, and when the user looks at the programmer at an angle, that is to say when this programmer is for example fitted into the wall socket 4 close to the floor.

It will also be understood that when two directly adjacent segments are in the open position, the two corresponding uncovered portions of the edge 13 extend directly one after the other along the periphery of the dial in such a way as to form a clearly visible uncovered zone in one piece.

The visibility of the programming ranges with open segment(s) is improved by providing that the edge 13 has a bright colouring by means of coloured pigments either deposited on the surface or mixed with the material forming at least this edge. Instead of this colouring or as a complement to it, the edge 13 can be back-lit from the interior of the housing 2. For this purpose the programmer 8 has at least one light guide shown schematically by the wavy arrows 40 only in FIG. 2. This or these light guide(s) is/are in practice formed from a plastics material of which the faces are shaped in order for the light entering in this manner to be reflected internally to a light diffusing face situated at the level of the edge 13. Several embodiments of this or these light guide(s) can be envisaged, as detailed below.

Furthermore, the programmer has a tubular collar 50 attached around the dial 10 in a coaxial manner. This collar comprises a tubular body 51 fitted around the wheel 11 and indexed in rotation with this latter by means of a lug 52 complementary to a recess 17 of the wheel. At its end facing towards the exterior of the housing 2, the body 51 is integral with a ring of ninety-six flexible strips 54 uniformly distributed around the periphery of this body and spaced from one another along this periphery. Each strip extends radially towards the exterior of the body 51 and has a bead 55 on its free end.

The lug 52 and the recess 17 are adapted to index the axial and angular positions of the collar 50 with respect to the dial 10 in such a way that when the body 51 is attached around the wheel 11 each end bead 55 is disposed in contact with one of the segments 30, substantially vertically in line with the ring 14, for the purpose of locking the segments in their open or closed position. For this purpose the curved outer face 31 B of the body 31 of each segment has in its end part turned towards the housing 2 two recesses 36 and 37 which are substantially complementary to the bead 55. The recess 36 receives this bead when the segment 30 is in the closed position, whilst the recess 37 receives it when the segment is in the open position. The recesses 36 and 37 are adjacent in a direction which is orthoradial with respect to the axis Z-Z in such a way that the bead 55 successively occupies the recesses 36 and 37 during the tilting of the segment 30.

Thus the segment 30 is retained in a stable position in each of its positions shown in FIG. 2 by the engagement of a corresponding bead 55 in one of its recesses 36 or 37.

Each recess 36, 37 has a cam surface 36A, 37A for the bead 55. These cam surfaces are shaped so as to push the bead 55 towards the housing 2 by means of a resilient deformation of the strip 54 indicated by an arrow 56 in FIG. 2 during the tilting of the segment 30. Moreover, the cam surfaces 36A and 37A are joined to one another in the region of a convex angular zone 38 (without a flat area) of the external face 31B of the segment 30, in such a way that when the bead 55 slides along one of the cam surfaces 36A, 37A as far as this zone 38 the bead immediately starts its introduction into the other recess under the restoring effect of the resilient strip 54. Thus the segment 30 passes freely from one open or closed position to the other without the possibility of stopping in an intermediate position.

According to a first embodiment, the light guides 40 have light guide bars opening below the edge 13 and provided in an analogous manner to that indicated by the wavy arrows in Figure 2, that is to say disposed both between the tabs 15 and the strips 54 along the periphery of the bodies 11 and 51 and also between this body 11 and the ribs 16 in a radial direction with respect to the axis X-X.

As a variant (not shown), one single light guide 40 is provided and is formed by the dial itself, its edge 13 then being the zone for diffusing the light guided internally through the rest of the dial. According to another variant (not shown) the light guide 40 is in the form of a substantially tubular piece attached coaxially between the dial 10 and the collar 50.

Various developments and variants of the programmer 8 and of the connector 1 which are described above can also be envisaged. By way of example, the arrangement and the nature of the plug 3 and-socket 5 are only illustrative and the invention applies to connectors in which the plugs and sockets are not coaxial with respect to the dial 10 and/or which are provided one or several faces of the housing 2 different from that of the dial 10. Moreover, the invention applies equally to connectors having several output sockets, only some of these sockets or all of the output sockets being controlled, from the point of view of the flow of current through the connector, by the programmer 8.

Moreover, as a variant (not shown) the shape of the external face 31B of each segment 30 is not limited to that shown in FIG. 4. This face 31B, in particular in the region of its part which is directed towards the user, can therefore be designed to give a certain external aesthetic appearance to the segments.

Moreover, although the illustrated example relates to a dial with ninety-six segments, this temporal sub-division does not limit the invention and the number of segments used can be higher or lower, for example it can be equal to one hundred and forty-four or to forty-eight.

The invention has been illustrated during its implementation in an electrical connector of the “programmable plug” type, that is to say a connector forming a unit which can be transported from one supply socket 4 to another. It also applies in the case of a programmable connector integrated into an electrical panel in order to control a fixed appliance such as a swimming pool filtration motor or an external lighting system.

1-12. (canceled)

13. Electromechanical programmer comprising a rotary display dial and rigid or semi-rigid segments for determining at least one programming range which are supported by the dial in such a way that they can move between two different control positions, each segment passing from one control position to the other by tilting about an axis of tilting which is orthoradial with respect to an axis of rotation of the dial, wherein each segment comprises a body with a substantially C-shaped cross-section of which the inner face directed towards the dial extends about the axis of tilting of the segment and includes a surface which in one control position covers an associated zone of the dial and in the other control position uncovers at least part of said zone of the dial and renders it visible from the exterior.

14. Programmer according to claim 13, further comprising coloured and/or luminous marking means for marking said zone of the dial.

15. Programmer according to claim 14, wherein the marking means comprise at least one light guiding element, adapted to guide a light to said zone of the dial.

16. Programmer according to claim 13, wherein the tilting angle of each segment between the two control positions has a value higher than 28°, preferably approximately 30°.

17. Programmer according to claim 13, wherein said zone of the dial forms a truncated cone converging towards the axis of rotation of the dial in the direction of a display face of the dial.

18. Programmer according to claim 17, wherein the apex angle of the said truncated cone is approximately 90°.

19. Programmer according to claim 13, wherein the face of each segment directed towards the dial also includes a surface provided with a mounting means for mounting so as to tilt on the dial.

20. Programmer according to claim 19, wherein the mounting means comprises a catch engaged on a ring of the dial, this ring being centred on the axis of rotation of the dial and having a circular cross-section centred on the axis of tilting of the segment.

21. Programmer according to claim 13, further comprising locking means for locking of each segment in each of its control positions, adapted in order to co-operate with the segment by means of complementary shapes.

22. Programmer according to claim 21, wherein each segment has two adjacent recesses to receive a complementary part of the locking means, and wherein the recesses have respective cam surfaces for the said complementary part which open onto one another and are adapted to push this part during the tilting of the segment, the locking means comprising an element for resiliently returning the complementary part to the base of the recesses.

23. Programmer according to claim 22, wherein the cam surfaces are joined directly to one another by a convex angular zone.

24. Programmable electrical connector comprising an electrical input plug, at least one electrical output socket and an electromechanical programmer according to claim 13, adapted to control the flow and the interruption of the current between the input plug and the or at least one of the output sockets.
